(19) United States
(12) Patent Application Publication
(10) Pub. No.: US 2022/0083667 A1
(43) Pub. Date: Mar. 17, 2022

(54) Open Source Software Security Vulnerability Prioritization Scheme

(71) Applicant: AT&T Intellectual Property I, L.P., Atlanta, GA (US)

(72) Inventors: Nadeem Anwar, Old Bridge, NJ (US); Rebecca Finnin, Atlanta, GA (US); Meenakshi Gurumoorthy, Basking Ridge, NJ (US); Giselle Gilmore, Fords, NJ (US)

(73) Assignee: AT&T Intellectual Property I, L.P., Atlanta, GA (US)

(21) Appl. No.: 17/022,210

(22) Filed: Sep. 16, 2020

(51) Int. Cl. G06F 21/57; G06F 8/75; G06F 8/65

(52) U.S. Cl. CPC G06F 21/577; G06F 8/75; G06F 9/45533; G06F 2221/033; G06F 8/65

(57) ABSTRACT

Concepts and technologies disclosed herein are directed to an open source security vulnerability prioritization scheme. According to one aspect disclosed herein, a software composition analysis system can obtain, from a vulnerability database, security vulnerability data about a set of known security vulnerabilities. The software composition analysis system can identify an application for analysis. The application can call a common library shared among a plurality of applications. The software composition analysis system can identify, based upon the set of known security vulnerabilities, a security vulnerability in the common library. The software composition analysis system can remediate the security vulnerability in the common library.

### BACKGROUND

Open source security vulnerability scanning tools are effective at finding security vulnerabilities within software and providing alerts for the security vulnerabilities to the software developer. Developers may receive only a few alerts that are easy to manage or hundreds of alerts that are difficult to remediate in a timely manner. Current open source security vulnerability scanning tools, however, provide little to no guidance on how to prioritize multiple security vulnerabilities, which makes vulnerability remediation a complex issue.

Some tools offer prioritization based upon criticality levels (e.g., critical, high, medium, or low) with stringent timelines defined by security organizations that do not allow the developers to determine an effective remediation plan, often leaving the developers overwhelmed, especially since the remediation of security vulnerabilities cannot be considered in isolation for overall risk mitigation. This inhibits the overall adoption and onboarding of tools that augment security.

Open source security vulnerabilities are often nested within software packages due to dependencies on other packages. This can create numerous false positives from security vulnerabilities in parts of the code that are not call by an application. If the developer does not have a dependency tree to determine the nested level of vulnerable packages, determining the security vulnerabilities to be fixed can become confusing and ineffective. Additionally, fixes to the code may not be readily available based on the software packages used. However, risk mitigation must be practical to ensure that code release management is not impaired due to fixes that are not available.

### SUMMARY

Concepts and technologies disclosed herein are directed to aspects of an open source security vulnerability prioritization scheme. According to one aspect of the concepts and technologies disclosed herein a software composition analysis system can obtain, from a vulnerability database, security vulnerability data about a set of known security vulnerabilities. The software composition analysis system can identify an application for analysis. The application can call a common library shared among a plurality of applications. The software composition analysis system can identify, based upon the set of known security vulnerabilities, a security vulnerability in the common library. The software composition analysis system can generate an application dependency tree for the application. The application dependency can include a direct dependency level and one or more transitive dependency levels. The software composition analysis system can remediate the security vulnerability in the common library.

The common library can include a plurality of common library software packages. The security vulnerability can affect a common library software package of the plurality of common library software packages. The common library software package of the plurality of common library software packages can reside in the direct dependency level of the application dependency tree. In these embodiments, the software composition analysis system can remediate the security vulnerability in the common library by upgrading the common library software package of the plurality of common library software packages to a software version that fixes the security vulnerability. The common library software package of the plurality of common library software packages can, alternatively, reside in one of the transitive dependency levels of the application dependency tree. In these embodiments, the software composition analysis system can remediate the security vulnerability in the common library by upgrading a second common library software package of the plurality of common library software packages to a software version that fixes the security vulnerability. The second common library software package of the plurality of common library software packages can reside in the direct dependency level of the application dependency tree.

In some embodiments, the application also calls an additional software package. The software composition analysis system can identify, based upon the set of known security vulnerabilities, the security vulnerability in the additional software package and can remediate the security vulnerability in the additional software package. In some embodiments, the additional software package resides in the direct dependency level of the application dependency tree. In these embodiments, the software composition analysis system can remediate the security vulnerability in the additional software package by upgrading the additional software package to a software version that fixes the security vulnerability. In some other embodiments, the additional software package resides in the transitive dependency level of the application dependency tree. In these embodiments, the software composition analysis system can remediate the security vulnerability in the additional software package by upgrading a further software package, from which the additional software package depends, to a software version that fixes the security vulnerability.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a diagram illustrating aspects of an illustrative operating environment for various concepts and technologies disclosed herein.

FIG. 2 is a diagram illustrating aspects of an illustrative application dependency tree, according to an illustrative embodiment of the concepts and technologies disclosed herein.

FIG. 3 is a flow diagram illustrating aspects of a method for implementing an open source security vulnerability prioritization scheme, according to an illustrative embodiment of the concepts and technologies disclosed herein.

FIG. 4 is a block diagram illustrating an example computer system, according to some illustrative embodiments.

FIG. 5 is a diagram illustrating a network, according to an illustrative embodiment.

FIG. 6 is a block diagram illustrating a cloud computing platform capable of implementing aspects of the concepts and technologies disclosed herein.

FIG. 7 is a block diagram illustrating a machine learning system capable of implementing aspects of the concept and technologies disclosed herein.

FIG. 8 is a block diagram illustrating an example mobile device and components thereof, according to an illustrative embodiment.

### DETAILED DESCRIPTION

The concepts and technologies disclosed herein provide an open source software vulnerability prioritization scheme that allows developers to effectively prioritize security vulnerabilities found by a software composition analysis scanning tool so that the security vulnerabilities can be effectively remediated. The prioritization scheme can be based upon factors, including common libraries, dependencies, vulnerability type, and a full dependency tree. The common libraries can include a collection of precompiled code that an application can use. An enterprise may have one or more common libraries that are shared among a plurality of applications. Fixing security vulnerabilities within a common library can eliminate alerts and fix security vulnerabilities in multiple applications that call the common library. The dependencies can be direct or transitive. A direct dependency is an open source package that is explicitly used by the developer. A transitive dependency is an open source package called by another open source package and is not explicitly used by the developer. The security vulnerabilities can be effective or ineffective. An effective security vulnerability includes vulnerable code that is executed by an application. An ineffective security vulnerability includes vulnerable code that is not executed by an application. The full dependency tree can be used to determine the nesting of embedded software packages. Embedded packages can be nested at the direct dependency level or the transitive dependency level. This adds additional complexity to security vulnerability mitigation.

A software developer may get open source security vulnerability alerts notifying them that one or more of their applications contains security vulnerabilities at various criticality levels and that a certain number of the security vulnerabilities are ranked at a high criticality level. Without a dependency tree, the software developer does not know which software packages within the application need to be fixed, if the software packages are directly dependent or transitively dependent packages, or if the software packages that contain the security vulnerabilities are effective (i.e., being called by the application(s)). Currently, open source security scanning tools provide developers with a list of vulnerabilities without a way to prioritize the vulnerabilities. The disclosed prioritization scheme provides developers with an actionable guideline on what vulnerabilities should be mitigated by considering common libraries, directly-dependent packages, and effective packages. The disclosed prioritization scheme also addresses the handling of the multilevel embedded packages by providing step-by-step guidance at each level. This streamlines the vulnerability remediation process and makes it more efficient.

Currently, developers spend time manually going through each security vulnerability and are unsure of an effective order in which to remediate the security vulnerabilities, which is frequently overwhelming and tedious for the developers. The disclosed prioritization scheme provides direction on which vulnerabilities are to be fixed, thereby reducing time spent on the remediation process. This allows developers to effectively manage their workload and remediate iteratively towards software release planning and save hundreds of labor hours for companies.

An example implementation of the disclosed prioritization scheme and the resultant savings in labor hours will now be described. Assuming a total of 1343 JAVA applications in a company's software portfolio, with 60% of those applications having an average of 24 security vulnerabilities per application, with 15% of the security vulnerabilities are in common libraries, and an average of 8 hours to fix each vulnerability, the total number of labor hours saved for all 1343 applications is 23,207.04 hours (i.e., 8×1343×0.60×24×0.15=23,207.04) or 17.28 hours per application. Thus, if the company can remediate only the common libraries, there is a cost avoidance of over 23,000 hours that developers would have to spend on attempting to fix all 1343 JAVA applications. This time can better spent on creating new features for existing applications, developing new applications, and/or other work.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

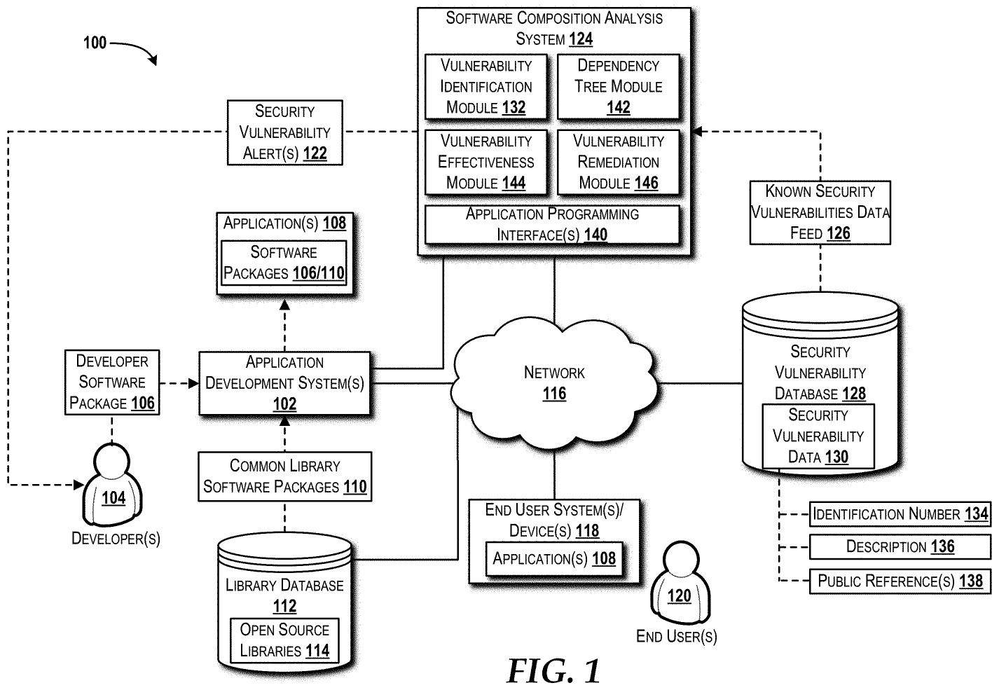

Turning now to FIG. 1, an operating environment 100 in which embodiments of the concepts and technologies disclosed herein will be described. The operating environment 100 can include one or more application development system(s) 102 (hereinafter referred to collectively as “application development systems 102” or individually as “application development system 102”) that can be utilized by one or more developers 104 (hereinafter referred to collectively as “developers 104” or individually as “developer 104”) to create one or more developer software packages 106 (hereinafter referred to collectively as “developer software packages 106” or individually as “developer software package 106”). For purposes of explanation, the developers 104 will be described as employees or contractors of a particular enterprise that develops multiple applications 108 (hereinafter referred to collectively as “applications 108” or individually as “application 108”) for in-house and/or external use. The developer software packages 106 can be combined with one or more common library software packages 110 (hereinafter referred to collectively as “common library software packages 110” or individually as “common library software packages 110”) obtained from a library database 112 (multiple databases are also contemplated) that stores one or more open source libraries 114 (hereinafter referred to collectively as “open source libraries 114” or individually as “open source library 114”) to create the applications 108. For example, the developer software package 106 may call one or more of the open source libraries 114 to utilize functionality contained in the common library software packages 110. From a development perspective, the developers 104 benefit from creating the developer software packages 106 that efficiently utilize existing functionality available from the open source libraries 114 rather than creating one-off code. Moreover, the nature of the open source libraries 114 enables cooperative development within the open source development community, of which the developers 104 may be a part.

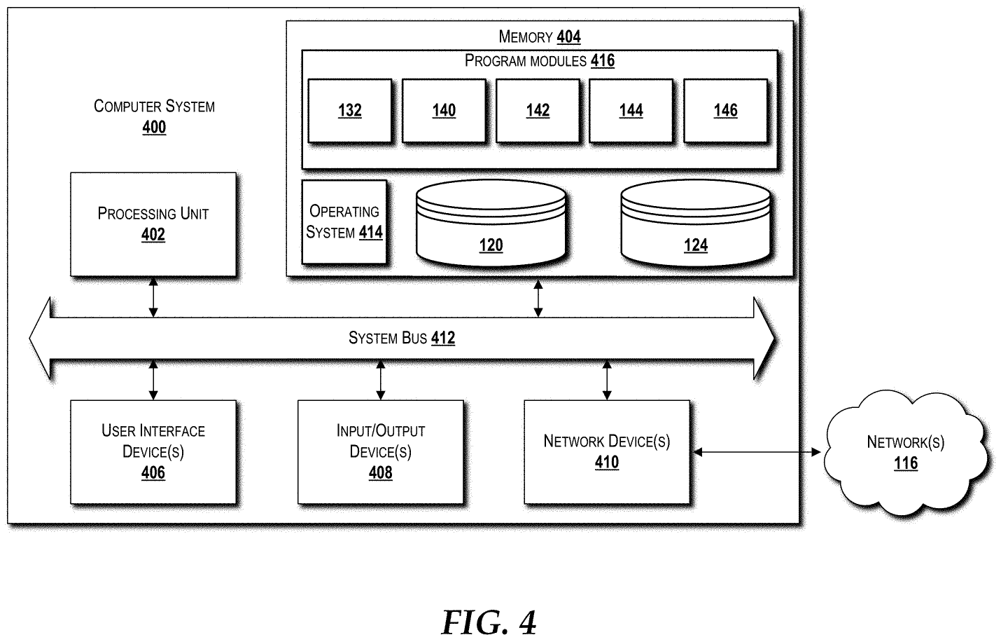

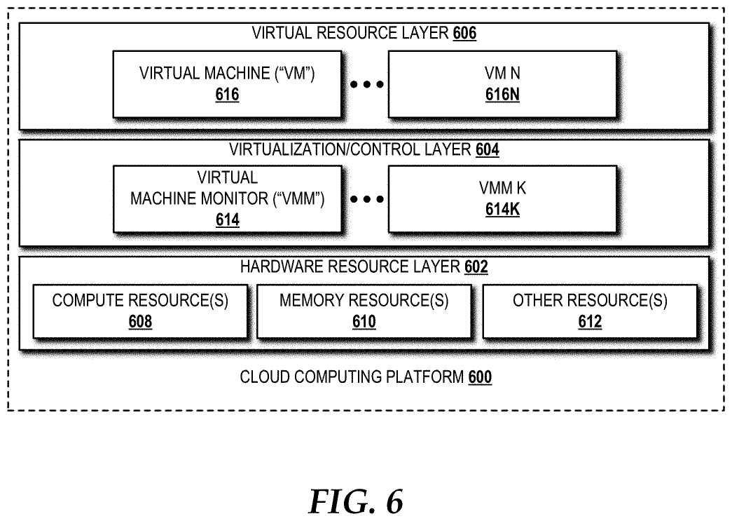

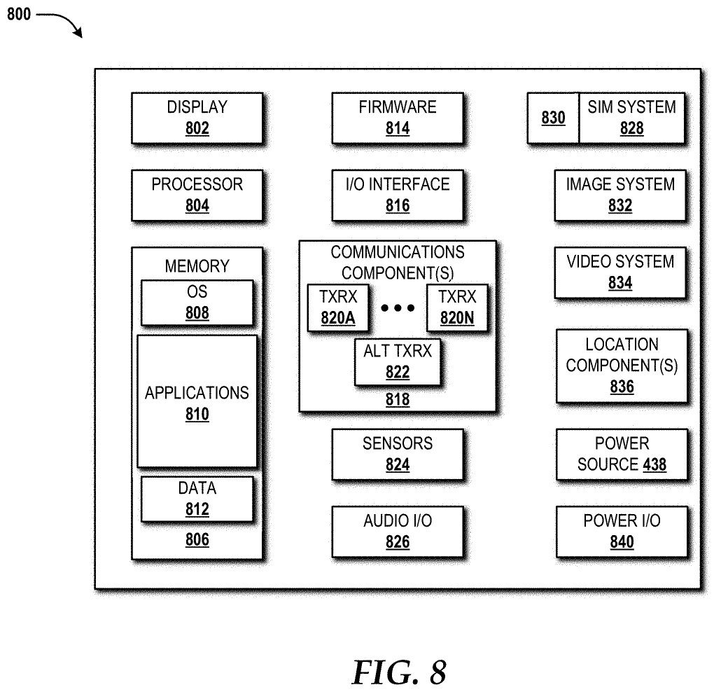

The application development system 102 can be implemented as a computing system or device, such as, for example, a desktop, a laptop, a tablet, or a smartphone. In particular, the application development system 102 can be configured the same as or similar to a computer system 400 illustrated and described with respect to FIG. 4 or a mobile device 800 illustrated and described with respect to FIG. 8. The application development system 102 alternatively or additionally can be implemented as a virtual machine 616 executed by a cloud computing platform 600 illustrated and described with respect to FIG. 6. The virtual machine 616 can be accessed by another application development system 102, such as a local computer system or device. Local virtual machines are also contemplated.

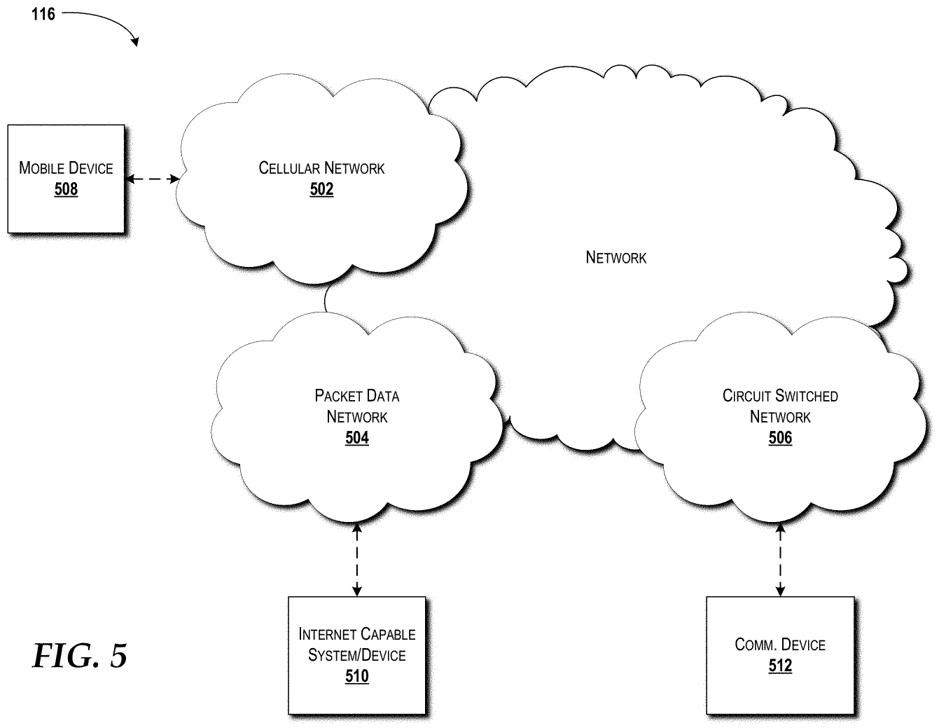

The developer software packages 106 can include software code created by the developers 104. The developer software packages 106 can be coded using any programming language, some examples of which include, but are not limited to, JAVA, JAVASCRIPT, PYTHON, C#, and C++. Proprietary programming languages are also contemplated. The developer software packages 106, in general, are software components developed to provide unique functionality of an application 108 (also referred to herein collectively as “applications 108”). The applications 108 can also utilize software components of one or more common library software packages 110 (hereinafter referred to collectively as “common library software packages 110” or individually as “common library software package 110”) obtained from a library database 112. The common library software packages 110 can be coded using any programming language, including any of the aforementioned examples. The common library software packages 110 can be shared among any number of the applications 108. The common library software packages 110 can be developed, at least in part, by the developers 104 alone or in combination with others (not shown) and uploaded or otherwise provided to the library database 112. The library database 112 can be external to or part of the application development systems 102. As an external database, the library database 112 can be accessible via a network 116, which can be a local network, a wide area network, the Internet, or other packet data network. An example of the network 116 is illustrated and described below with reference to FIG. 5.

After development, the applications 108 can be distributed to one or more end user systems and/or one or more end user devices 118 (hereinafter referred to collectively as “end user systems/devices 118” or individually as “end user system/device 118”). The applications 108 can be installed on the end user systems/devices 118 and utilized by one or more end users 120 (hereinafter referred to collectively as “end users 120” or individually as “end users 120”). The end users 120 can be employees or contractors that work for the same enterprise as the developers 104, such as if the application 108 is for enterprise-use only. Alternatively, the end users 120 can be normal users that may download the application 108 to the end user system/device 118 from an application marketplace (not shown) such as the APPLE APP STORE or GOOGLE PLAY STORE, a website, or elsewhere.

From time-to-time, the developers 104 may receive one or more security vulnerability alerts 122 (hereinafter referred to collectively as “security vulnerability alerts 122” or individually as “security vulnerability alert 122”) from a software composition analysis system 124. The security vulnerability alerts 122 can be generated by the software composition analysis system 124 based upon a known security vulnerabilities data feed 126 received from a security vulnerability database 128 that maintains security vulnerability data 130 about known security vulnerabilities. Moreover, the software composition analysis system 124 can execute, via one or more processors, a vulnerability identification module 132 to analysis the applications 108 to determine whether any of the developer software packages 106 and/or the common library software packages 110 (shown as “software packages 106/110”) contain any known security vulnerabilities identified in the security vulnerability data 130. In this manner, the developers 104 can be alerted only to the known security vulnerabilities that are applicable to the applications 108.

The security vulnerability database 128 obtains and maintains the security vulnerability data 130. In some embodiments, the security vulnerability database 128 includes the Common Vulnerabilities and Exposures (“CVE”) dictionary (also referred to as a “list”) or otherwise provides access thereto. The CVE dictionary provides definitions for publicly disclosed security vulnerabilities and exposures. Each entry in the CVE dictionary includes an identification number 134, a description 136, and at least one public reference 138. It should be understood that although the CVE dictionary is referenced as a particular source of the security vulnerability data 130, the security vulnerability database 128 can obtain the security vulnerability data 130 from other sources. Accordingly, the use of the CVE dictionary should not be construed as being limiting in any way.

The vulnerability identification module 132 can call one or more application programming interfaces (“APIs”) 140 that are exposed by the security vulnerability database 128 to subscribe to or otherwise obtain the known security vulnerabilities data feed 126. Alternatively, the vulnerability identification module 132 can obtain the known security vulnerabilities data feed 126 via a really simple syndication (“RSS”) feed, an email mailing list, a social media (e.g., TWITTER) account, text messages, combinations thereof, and/or the like.

The software composition analysis system 124 can be implemented as a computing system or device, such as, for example, a desktop, laptop, or tablet. In particular, the software composition analysis system 124 can be configured the same as or similar to the computer system 400 illustrated and described with respect to FIG. 4 or the mobile device 800 illustrated and described with respect to FIG. 8. The software composition analysis system 124 can be implemented as a virtual machine 616 executed by the cloud computing platform 600 illustrated and described with respect to FIG. 6.

The illustrated software composition analysis system 124 includes, in addition to the vulnerability identification module 132 and the API(s) 140, a dependency tree module 142, a vulnerability effectiveness module 144, and a vulnerability remediation module 146. Although individual modules are illustrated and may be separately executed by the software composition analysis system 124, the software composition analysis system 124 may execute a single application that includes the functionality provided all or some combination of the illustrated modules. The software composition analysis system 124 can provide additional functionality for which a specific module is not shown. The software composition analysis system 124 can be provided, as in the illustrated embodiment, as a system that is distinct from the application development systems 102. Alternatively, the software composition analysis system 124 can be implemented as part of the application development systems 102. Moreover, the software composition analysis system 124 may be local to the application development system 102 or accessible by the application development systems 102 via the network 116. For these reasons, the illustrated embodiment of the software composition analysis system 124 should not be construed as being limiting in any way.

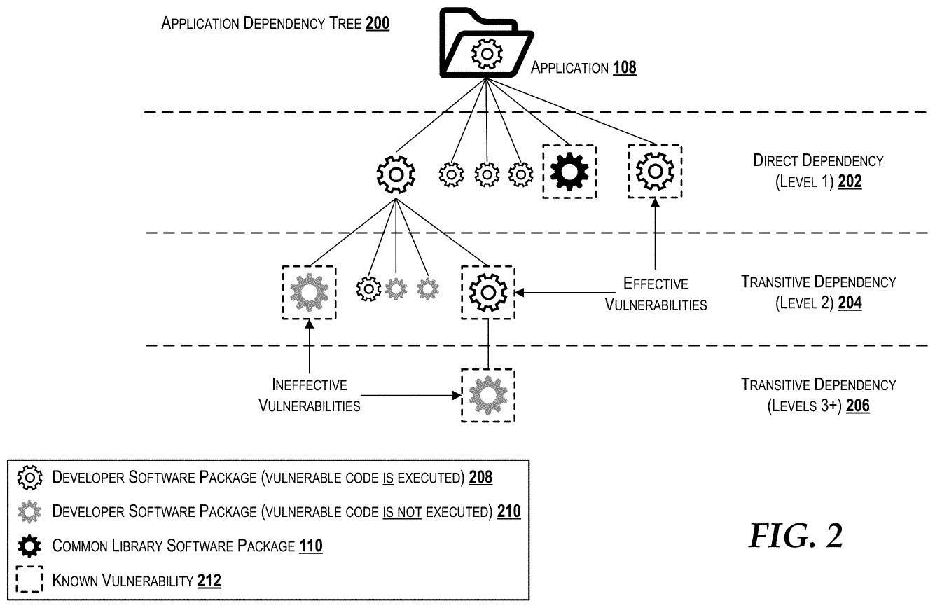

The dependency tree module 142 can analyze the application 108 to determine the dependencies among the software packages 106/110 utilized by the application 108. The dependencies can be direct or transitive. A direct dependency is an open source package (e.g., a common library software package 110) that is explicitly used by the developer 104. A transitive dependency is an open source package called by another open source package (e.g., one common library software package 110 that calls another common library software package 110) and is not explicitly used by the developer 104. The dependency tree module 142 can utilize this dependency information to create an application dependency tree. An example application dependency tree 200 is described below with reference to FIG. 2.

The vulnerability effectiveness module 144 can analyze the known security vulnerabilities data feed 126 and the composition of the application 108 to determine which security vulnerabilities are effect and which security vulnerabilities are ineffective. An effective security vulnerability includes vulnerable code that is executed by the application 108. An ineffective security vulnerability includes vulnerable code that is not executed by the application 108. This is referred to herein as the effectiveness of the vulnerability. The vulnerability effectiveness module 144 can share this effectiveness information with the dependency tree module 142.

Turning briefly to FIG. 2, the application dependency tree 200 for the application 108 is shown. The application dependency tree 200 includes a direct dependency level (level 1) 202 and one or more transitive dependency levels (levels 2 through 3+) 204-206. In the illustrated example, the direct dependency level (level 1) 202 includes five developer software packages 106 and one common library software package 110; the transitive dependency level (level 2) 204 includes five developer software packages 106; and the transitive dependency level (level 3) 206 includes one developer software package 106. The developer software packages 106 are identified based on whether vulnerable code is executed (shown as 208) or is not executed (shown as 210). Software packages that contain a known vulnerability are identified and shown as 212.

Returning to FIG. 1, the software composition analysis system 124 can execute the vulnerability remediation module 146 to remediate known security vulnerabilities in the application 108. In some embodiments, the vulnerability remediation module 146 can be configured to prioritize vulnerability remediation within the common library software packages 110 over the developer software packages 106. In particular, the software composition analysis system 124 can execute the vulnerability remediation module 146 to fix all security vulnerabilities within the common library software packages 110 to eliminate the security vulnerability alerts 122 in the identified application 108, and potentially in one or more other applications 108 that call the common library software packages 110. For common libraries, all direct and transitive dependencies should be upgraded to non-vulnerable versions. If the vulnerable packages are direct packages (i.e., level 1 in the application dependency tree 200), the software composition analysis system 124 can provide direction to the developer 104 regarding to which package version the vulnerable package should be upgraded. If the vulnerable packages are level 2 and deeper used by the level 1 package, the developer 104 can be instructed to find the version of the direct level 1 package that is non-vulnerable and upgrade to that version. This process can be repeated for every transitive package.

After the security vulnerabilities in the common library software packages 110 are remediated, the software composition analysis system 124 can remediate other vulnerable software packages, such as the developer software packages 106 that contain one or more security vulnerabilities. In particular, if the vulnerable software packages are direct packages (i.e., level 1 in the application dependency tree 200), the software composition analysis system 124 can provide direction to the developer 104 regarding to which package version the vulnerable package should be upgraded. For the purpose of ensuring that the application 108 no longer contains any direct packages that contain security vulnerabilities, the direct packages should be fixed. For software packages that are level 2 and are used by the level 1 package(s), the developer 104 can be instructed to find the version of the direct level 1 package that is non-vulnerable and upgrade to that version. Otherwise, transitive packages (i.e., packages not explicitly used by the developer) that are level 3 and deeper can be marked as ignored and/or can be fixed as time permits. In addition to direct and transitive software packages, software packages that contain effective vulnerabilities and ineffective vulnerabilities can be separated. Information about which software packages contain effective vulnerabilities and which software packages contain ineffective vulnerabilities can be obtained through the API 140. All direct dependency packages with effective or ineffective vulnerabilities should be upgraded to non-vulnerable versions. All level 2 transitive dependency packages with effective or ineffective vulnerabilities should be upgraded to non-vulnerable versions. All level 3 and deeper level transitive dependences should be remediated as time permits.

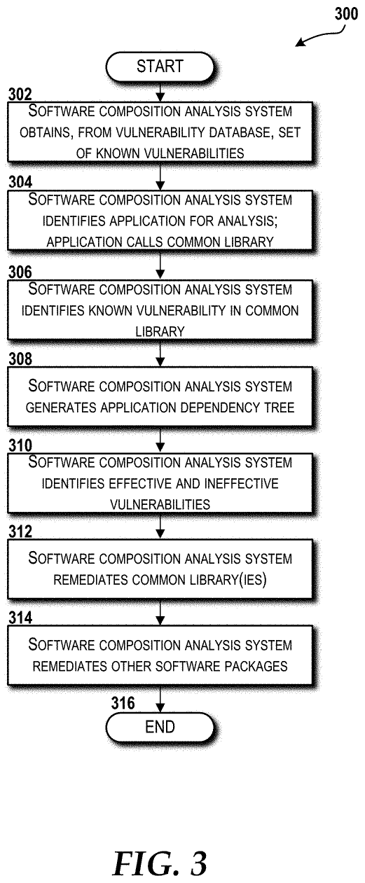

Turning now to FIG. 3, a flow diagram illustrating aspects of a method 300 for implementing an open source security vulnerability prioritization scheme will be described, according to an illustrative embodiment of the concepts and technologies disclosed herein. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described with reference to FIG. 3 and further reference to FIGS. 1 and 2. The method 300 will be described from the perspective of the software composition analysis system 124 executing, by at least one processor, the vulnerability identification module 132, the dependency tree module 142, the vulnerability effectiveness module 144, and the vulnerability remediation module 146.

The method 300 begins and proceeds to operation 302. At operation 302, the software composition analysis system 124, via execution of the vulnerability identification module 132, obtains, from the security vulnerability database 128, the known security vulnerabilities data feed 126 that contains the security vulnerability data 130 that identifies a set of known security vulnerabilities. The software composition analysis system 124 may, by default, request all of the known security vulnerabilities from the security vulnerability database 128. Alternatively, the software composition analysis system 124 may request only specific security vulnerabilities or subsets of the security vulnerabilities (e.g., based upon type, criticality, age, and/or other criteria). In some embodiments, the vulnerability identification module 132 may provide a user interface through which a person or other entity, such as the developer 104, can input criteria upon which to filter the security vulnerabilities. In this manner, the set of known security vulnerabilities can be pre-filtered to alleviate at least some processing overhead to perform the remaining operations of the method 300.

From operation 302, the method 300 proceeds to operation 304. At operation 304, the software composition analysis system 124 identifies one of the applications 108 for analysis. In this example, it is assumed that the application 108 calls at least one of the common library software packages 110 contained in a single open source library 114 that is utilized by multiple applications 108. Although a single open source library will be used as an example for the remaining operations of the method 300, multiple common libraries may be used by the application 108, and likely will be in practice. Moreover, while the operation 304 and the remaining operations of the method 300 are described as being performed in context of a single application 108, the software composition analysis system 124 can, in some embodiments, perform these operations in parallel for multiple applications 108. It is contemplated that parallel processing may be used for the applications 108 that share the same open source libraries 114, although this is not necessarily the case. From operation 304, the method proceeds to operation 306. At operation 306, the software composition analysis system 124, via execution of the vulnerability identification module 132, identifies at least one known vulnerability in the set of known vulnerabilities that affects the open source library 114.

From operation 306, the method 300 proceeds to operation 308. At operation 308, the software composition analysis system 124, via execution of the dependency tree module 142, generates an application dependency tree (an example of which is shown as 200 in FIG. 2). An automated script or one of the APIs 140 can be used to pull information used to generate the application dependency tree 200. The application dependency tree 200 can show the nested levels of the software packages 106/110 being used and what packages contain security vulnerabilities in the application 108.

From operation 308, the method 300 proceeds to operation 310. At operation 310, the software composition analysis system 124, via execution of the vulnerability effectiveness module 144, identifies effective and ineffective vulnerabilities. Also, at operation 310, the dependency tree module 142 can update the application dependency tree 200 to reflect the effective and ineffective vulnerabilities.

From operation 310, the method 300 proceeds to operation 312. At operation 312, the software composition analysis system 124, via execution of the vulnerability remediation module 146, remediates the open source library 114. In particular, the software composition analysis system 124 can fix all vulnerabilities within the open source library 114 to eliminate the security vulnerability alerts 122 and fix vulnerabilities in the application 108, and potentially in one or more other applications 108 that call the open source library 114. All direct and transitive dependencies should be upgraded to non-vulnerable versions. If the vulnerable packages are direct packages (i.e., level 1), the software composition analysis system can provide direction to the developer regarding to which package version the vulnerable package should be upgraded. If the vulnerable packages are level 2 and deeper used by the level 1 package, the developer can be instructed to find the version of the direct level 1 package that is non-vulnerable and upgrade to that version. This process can be repeated for every transitive package.

From operation 312, the method 300 proceeds to operation 314. At operation 314, the software composition analysis system 124 remediates other vulnerable software packages, including, for example, other libraries and other enterprise applications. In particular, if the vulnerable software packages are direct packages (i.e., level 1 in the application dependency tree), the software composition analysis system 124 can provide direction to the developer regarding to which package version the vulnerable package should be upgraded. For purposed of ensuring that the application no longer contains any direct packages that contain security vulnerabilities, the direct packages should be fixed. For software packages that are level 2 and are used by the level 1 package(s), the developer can be instructed to find the version of the direct level 1 package that is non-vulnerable and upgrade to that version. Otherwise, transitive packages (i.e., packages not explicitly used by the developer) that are three levels and deeper can be marked as ignored and/or can be fixed as time permits. In addition to direct and transitive software packages, software packages that contain effective vulnerabilities and ineffective vulnerabilities can be separated. Information about which software packages contain effective vulnerabilities and which software packages contain ineffective vulnerabilities can be obtained through the API. All direct dependency packages with effective or ineffective vulnerabilities should be upgraded to non-vulnerable versions. All level 2 transitive dependency packages with effective or ineffective vulnerabilities should be upgraded to non-vulnerable versions. All level 3 and deeper level transitive dependences should be remediated as time permits.

From operation 314, the method 300 proceeds to operation 316. At operation 316, the method can end.

Turning now to FIG. 4, a block diagram illustrating a computer system 400 configured to provide the functionality described herein in accordance with various embodiments of the concepts and technologies disclosed herein will be described. In some embodiments, the application development system(s) 102, the software composition analysis system 124, the end user system(s)/device(s), one or more components thereof, and/or other systems/devices disclosed herein can be configured like and/or can have an architecture similar or identical to the computer system 400 described herein with respect to FIG. 4. It should be understood, however, that any of these systems, devices, or elements may or may not include the functionality described herein with reference to FIG. 4.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the computer system 400.

The memory 404 communicates with the processing unit 402 via the system bus 412. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 416 can include various software and/or program modules described herein, such as the vulnerability identification module 132, the dependency tree module 142, the vulnerability effectiveness module 144, the vulnerability remediation module 146, and the APIs 140, for embodiments in which the software composition analysis system 124 is implemented based, at least in part, upon the architecture of the computer system 400. For embodiments in which the application development system 102 is implemented based, at least in part, upon the architecture of the computer system 400, the program modules 416 can include software development tools for use by the developers 104 to create the developer software packages 106 and the applications 108. For embodiments in which the end user system/device 118 is implemented based, at least in part, upon the architecture of the computer system 400, the program modules 416 can include the application(s) 108.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer to output data.

The network devices 410 enable the computer system 400 to communicate with other networks or remote systems via one or more networks, such as the network 116 (best shown in FIGS. 1 and 5). Examples of the network devices 410 include, but are not limited to, a modem, a RF or infrared (“IR”) transceiver, a telephonic interface, a bridge, a router, or a network card. The network(s) may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a Worldwide Interoperability for Microwave Access (“WiMAX”) network, or a cellular network. Alternatively, the network(s) may be a wired network such as, but not limited to, a WAN such as the Internet, a LAN, a wired PAN, or a wired MAN.

Turning now to FIG. 5, additional details of an embodiment of the network 116 will be described, according to an illustrative embodiment. In the illustrated embodiment, the network 116 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured to utilize any using any wireless communications technology or combination of wireless communications technologies, some examples of which include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The mobile communications device 508 can communicate with the cellular network 502 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the mobile communications device 508 and the cellular network 502 via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the cellular network 502 may additionally include backbone infrastructure that operates on wired communications technologies, including, but not limited to, optical fiber, coaxial cable, twisted pair cable, and the like to transfer data between various systems operating on or in communication with the cellular network 502.

The packet data network 504 can include various devices, for example, the application development system(s) 102, the software composition analysis system 124, the end user system(s)/device(s) 118, the security vulnerability database 128, servers, computers, databases, and other systems/devices in communication with one another. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet.

The circuit switched network 506 includes various hardware and software for providing circuit switched communications. The circuit switched network 506 may include, or may be, what is often referred to as a plain old telephone system (“POTS”). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable systems/devices 510, for example, the application development system(s) 102, the software composition analysis system 124, the end user system(s)/device(s) 118, the security vulnerability database 128, a personal computer (“PC”), a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. It should be appreciated that substantially all of the functionality described with reference to the network 318 can be performed by the cellular network 502, the packet data network 504, and/or the circuit switched network 506, alone or in combination with additional and/or alternative networks, network elements, and the like.

Turning now to FIG. 6, a cloud computing platform architecture 600 capable of implementing aspects of the concepts and technologies disclosed herein will be described, according to an illustrative embodiment. In some embodiments, the application development system(s) 102, the software composition analysis system 124, the end user system(s)/device(s) 118, and/or the security vulnerability database 128 can be implemented, at least in part, on the cloud computing platform architecture 600. Those skilled in the art will appreciate that the illustrated cloud computing platform architecture 600 is a simplification of but one possible implementation of an illustrative cloud computing platform, and as such, the cloud computing platform architecture 600 should not be construed as limiting in any way.

The illustrated cloud computing platform architecture 600 includes a hardware resource layer 602, a virtualization/control layer 604, and a virtual resource layer 606 that work together to perform operations as will be described in detail herein. While connections are shown between some of the components illustrated in FIG. 6, it should be understood that some, none, or all of the components illustrated in FIG. 6 can be configured to interact with one other to carry out various functions described herein. In some embodiments, the components are arranged so as to communicate via one or more networks (not shown). Thus, it should be understood that FIG. 6 and the following description are intended to provide a general understanding of a suitable environment in which various aspects of embodiments can be implemented, and should not be construed as being limiting in any way.

The hardware resource layer 602 provides hardware resources, which, in the illustrated embodiment, include one or more compute resources 608, one or more memory resources 610, and one or more other resources 612. The compute resource(s) 606 can include one or more hardware components that perform computations to process data, and/or to execute computer-executable instructions of one or more application programs, operating systems, and/or other software. The compute resources 608 can include one or more central processing units (“CPUs”) configured with one or more processing cores. The compute resources 608 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 608 can include one or more discrete GPUs. In some other embodiments, the compute resources 608 can include CPU and GPU components that are configured in accordance with a co-processing CPU/GPU computing model, wherein the sequential part of an application executes on the CPU and the computationally-intensive part is accelerated by the GPU. The compute resources 608 can include one or more system-on-chip (“SoC”) components along with one or more other components, including, for example, one or more of the memory resources 610, and/or one or more of the other resources 612. In some embodiments, the compute resources 608 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 608 can be or can include one or more hardware components architected in accordance with an ARM architecture, available for license from ARM HOLDINGS of Cambridge, United Kingdom. Alternatively, the compute resources 608 can be or can include one or more hardware components architected in accordance with an x86 architecture, such an architecture available from INTEL CORPORATION of Mountain View, Calif., and others. Those skilled in the art will appreciate the implementation of the compute resources 608 can utilize various computation architectures, and as such, the compute resources 608 should not be construed as being limited to any particular computation architecture or combination of computation architectures, including those explicitly disclosed herein.

The memory resource(s) 610 can include one or more hardware components that perform storage operations, including temporary or permanent storage operations. In some embodiments, the memory resource(s) 610 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 608.

The other resource(s) 612 can include any other hardware resources that can be utilized by the compute resources(s) 606 and/or the memory resource(s) 610 to perform operations. The other resource(s) 612 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more virtual machine monitors (“VMMs”) 614A-614K (also known as “hypervisors”; hereinafter “VMMs 614”) operating within the virtualization/control layer 604 to manage one or more virtual resources that reside in the virtual resource layer 606. The VMMs 614 can be or can include software, firmware, and/or hardware that alone or in combination with other software, firmware, and/or hardware, manages one or more virtual resources operating within the virtual resource layer 606.

The virtual resources operating within the virtual resource layer 606 can include abstractions of at least a portion of the compute resources 608, the memory resources 610, the other resources 612, or any combination thereof. These abstractions are referred to herein as virtual machines (“VMs”). In the illustrated embodiment, the virtual resource layer 606 includes VMs 616A-616N (hereinafter “VMs 616”).

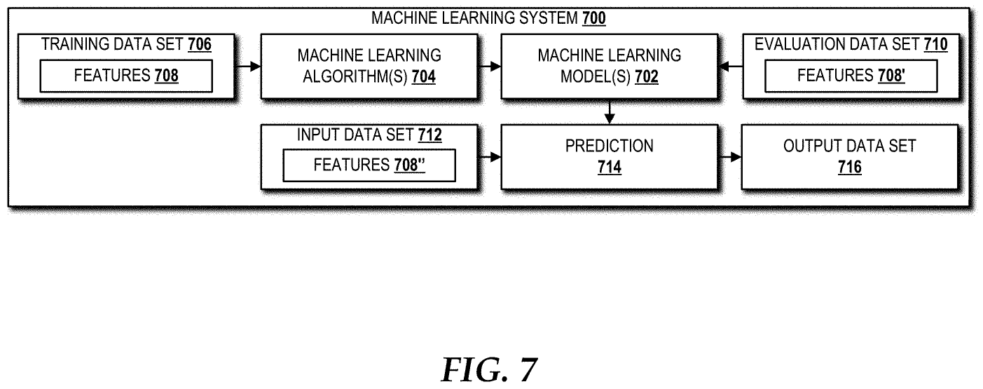

Turning now to FIG. 7, a machine learning system 700 capable of implementing aspects of the embodiments disclosed herein will be described. In some embodiments, the software composition analysis system 124 can be configured to provide machine learning functionality for use in vulnerability identification, software composition analysis, dependency tree generation, and/or other aspects of the concepts and technologies disclosed herein.

The illustrated machine learning system 700 includes one or more machine learning models 702. The machine learning models 702 can include supervised and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 706 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 708 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

Turning now to FIG. 8, an illustrative mobile device 800 and components thereof will be described. In some embodiments, the application development system(s) 102, the software composition analysis system 124, the end user system(s)/device(s) 118, the security vulnerability database 128 is/are configured similar to or the same as the mobile device 800. While connections are not shown between the various components illustrated in FIG. 8, it should be understood that some, none, or all of the components illustrated in FIG. 8 can be configured to interact with one another to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810, other computer-executable instructions stored in the memory 806, or the like. In some embodiments, the applications 810 also can include a UI application (not illustrated in FIG. 8).

The UI application can interface with the operating system 808 to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering/deleting data, entering and setting user IDs and passwords for device access, configuring settings, manipulating content and/or settings, multimode interaction, interacting with other applications 810, and otherwise facilitating user interaction with the operating system 808, the applications 810, and/or other types or instances of data 812 that can be stored at the mobile device 800.

The applications 810, the data 812, and/or portions thereof can be stored in the memory 806 and/or in a firmware 814, and can be executed by the processor 804. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interface 816 can be configured to support the input/output of data such as location information, presence status information, user IDs, passwords, and application initiation (start-up) requests. In some embodiments, the I/O interface 816 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks, such as the network 116, the Internet, or some combination thereof. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments, one or more of the transceivers of the communications component 818 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 818 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 818 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 818 can include a first transceiver (“TxRx”) 820A that can operate in a first communications mode (e.g., GSM). The communications component 818 also can include an Nth transceiver (“TxRx”) 820N that can operate in a second communications mode relative to the first transceiver 820A (e.g., UMTS). While two transceivers 820A-820N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to an MMS message, email message, and sent to another device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from global positioning system (“GPS”) devices, assisted-GPS (“A-GPS”) devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 800 or other devices or computers described herein, such as the computer system 400 described above with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 800 in order to store and execute the software components presented herein. It is also contemplated that the mobile device 800 may not include all of the components shown in FIG. 8, may include other components that are not explicitly shown in FIG. 8, or may utilize an architecture completely different than that shown in FIG. 8.

Based on the foregoing, it should be appreciated that aspects of an open source security vulnerability prioritization scheme has been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
obtaining, by a software composition analysis system, from a vulnerability database, security vulnerability data about a set of known security vulnerabilities;
identifying, by the software composition analysis system, an application for analysis, wherein the application calls a common library shared among a plurality of applications;
identifying, by the software composition analysis system, based upon the set of known security vulnerabilities, a security vulnerability in the common library; and
remediating, by the software composition analysis system, the security vulnerability in the common library.

2. The method of claim 1, further comprising generating, by the software composition analysis system, an application dependency tree for the application, wherein the application dependency tree comprises a direct dependency level and a transitive dependency level.

3. The method of claim 2, wherein:
the common library comprises a plurality of common library software packages;
the security vulnerability affects a common library software package of the plurality of common library software packages, wherein the common library software package of the plurality of common library software packages resides in the direct dependency level of the application dependency tree; and
remediating, by the software composition analysis system, the security vulnerability in the common library comprises upgrading the common library software package of the plurality of common library software packages to a software version that fixes the security vulnerability.

4. The method of claim 2, wherein:
the common library comprises a plurality of common library software packages;
the security vulnerability affects a common library software package of the plurality of common library software packages, wherein the common library software package of the plurality of common library software packages resides in the transitive dependency level of the application dependency tree; and
remediating, by the software composition analysis system, the security vulnerability in the common library comprises upgrading a second common library software package of the plurality of common library software packages to a software version that fixes the security vulnerability, wherein the second common library software package of the plurality of common library software packages resides in the direct dependency level of the application dependency tree.

5. The method of claim 2, wherein the application also calls an additional software package, and wherein the method further comprises:
identifying, by the software composition analysis system, based upon the set of known security vulnerabilities, the security vulnerability in the additional software package; and
remediating, by the software composition analysis system, the security vulnerability in the additional software package.

6. The method of claim 5, wherein the additional software package resides in the direct dependency level of the application dependency tree; and wherein remediating, by the software composition analysis system, the security vulnerability in the additional software package comprises upgrading the additional software package to a software version that fixes the security vulnerability.

7. The method of claim 5, wherein the additional software package resides in the transitive dependency level of the application dependency tree; and wherein remediating, by the software composition analysis system, the security vulnerability in the additional software package comprises upgrading a further software package, from which the additional software package depends, to a software version that fixes the security vulnerability.

8. A computer-readable storage medium comprising computer-executable instructions that, when executed by a processor, cause the processor to perform operations comprising:
obtaining, from a vulnerability database, security vulnerability data about a set of known security vulnerabilities;
identifying an application for analysis, wherein the application calls a common library shared among a plurality of applications;
identifying, based upon the set of known security vulnerabilities, a security vulnerability in the common library; and
remediating the security vulnerability in the common library.

9. The computer-readable storage medium of claim 8, wherein the operations further comprise generating an application dependency tree for the application, wherein the application dependency tree comprises a direct dependency level and a transitive dependency level.

10. The computer-readable storage medium of claim 9, wherein:
the common library comprises a plurality of common library software packages;
the security vulnerability affects a common library software package of the plurality of common library software packages, wherein the common library software package of the plurality of common library software packages resides in the direct dependency level of the application dependency tree; and
remediating the security vulnerability in the common library comprises upgrading the common library software package of the plurality of common library software packages to a software version that fixes the security vulnerability.

11. The computer-readable storage medium of claim 9, wherein:
the common library comprises a plurality of common library software packages;
the security vulnerability affects a common library software package of the plurality of common library software packages, wherein the common library software package of the plurality of common library software packages resides in the transitive dependency level of the application dependency tree; and
remediating the security vulnerability in the common library comprises upgrading a second common library software package of the plurality of common library software packages to a software version that fixes the security vulnerability, wherein the second common library software package of the plurality of common library software packages resides in the direct dependency level of the application dependency tree.

12. The computer-readable storage medium of claim 9, wherein the application also calls an additional software package; and wherein the operations further comprise:
identifying, based upon the set of known security vulnerabilities, the security vulnerability in the additional software package; and
remediating the security vulnerability in the additional software package.

13. The computer-readable storage medium of claim 12, wherein the additional software package resides in the direct dependency level of the application dependency tree;
and wherein remediating the security vulnerability in the additional software package comprises upgrading the additional software package to a software version that fixes the security vulnerability.

14. The computer-readable storage medium of claim 12, wherein the additional software package resides in the transitive dependency level of the application dependency tree; and wherein remediating the security vulnerability in the additional software package comprises upgrading a further software package, from which the additional software package depends, to a software version that fixes the security vulnerability.

15. A system comprising:
a processor; and
memory comprising computer-executable instructions that, when executed by the processor, cause the processor to perform operations comprising
obtaining, from a vulnerability database, security vulnerability data about a set of known security vulnerabilities,
identifying an application for analysis, wherein the application calls a common library shared among a plurality of applications,
identifying, based upon the set of known security vulnerabilities, a security vulnerability in the common library, and
remediating the security vulnerability in the common library.

16. The system of claim 15, further comprising generating an application dependency tree for the application, wherein the application dependency tree comprises a direct dependency level and a transitive dependency level.

17. The system of claim 16, wherein:
the common library comprises a plurality of common library software packages;
the security vulnerability affects a common library software package of the plurality of common library software packages, wherein the common library software package of the plurality of common library software packages resides in the direct dependency level of the application dependency tree; and
remediating the security vulnerability in the common library comprises upgrading the common library software package of the plurality of common library software packages to a software version that fixes the security vulnerability.

18. The system of claim 16, wherein:
the common library comprises a plurality of common library software packages;
the security vulnerability affects a common library software package of the plurality of common library software packages, wherein the common library software package of the plurality of common library software packages resides in the transitive dependency level of the application dependency tree; and
remediating the security vulnerability in the common library comprises upgrading a second common library software package of the plurality of common library software packages to a software version that fixes the security vulnerability, wherein the second common library software package of the plurality of common library software packages resides in the direct dependency level of the application dependency tree.

19. The system of claim 16, wherein the application also calls an additional software package; and further comprising:
identifying, based upon the set of known security vulnerabilities, the security vulnerability in the additional software package; and
remediating the security vulnerability in the additional software package.

20. The system of claim 19, wherein the additional software package resides in either the direct dependency level or the transitive dependency level of the application dependency tree; wherein if the additional software package resides in the direct dependency level, remediating the security vulnerability in the additional software package comprises upgrading the additional software package to a software version that fixes the security vulnerability; and wherein if the additional software package resides in the transitive dependency level, remediating the security vulnerability in the additional software package comprises upgrading a further software package, from which the additional software package depends, to a software version that fixes the security vulnerability.
